(19) United States
(12) Patent Application Publication
(10) Pub. No.: US 2014/0180937 A1
(43) Pub. Date: Jun. 26, 2014

(54) Machine Management System

(71) Applicant: John Paul Reiter, Richfield, MN (US)

(72) Inventor: John Paul Reiter, Richfield, MN (US)

(21) Appl. No.: 13/725,047

(22) Filed: Dec. 21, 2012

(51) Int. Cl. G06Q 30/00

(52) U.S. Cl. CPC G06Q 30/018
USPC 705/317

(57) ABSTRACT

The present embodiment is an online audit management system that may be used for managing a plurality of machine safety audits. The embodiment comprises at least one customer associated with a customer account, at least one user sign on associated with the at least one customer, a home page, an about page, an administration page, a profile page, a contacts page, a reports page configured to include a pair of pre-packaged reports, a toolbox page configured to include a plurality of tools, a machines page configured to manage information of a plurality of machines, an audits page configured to manage plurality of machine safety audits, a help page and a remote database configured to store data related to the plurality of machine safety audits. The system allows the at least one user to conduct and store the plurality of machine safety audits in a simple, secure and cost-effective manner.

### BACKGROUND OF THE INVENTION

1. Technical Field of the Invention

The present invention relates in general to systems for managing machine safety audits. More specifically, the present invention relates to an improved system for conducting and storing machine safety audits in a secure manner.

2. Description of the Related Art

Safety management systems are developed to manage machine safety audits that are required by OSHA (Occupational Safety and Health Administration). Such systems help to increase workplace safety, reduce liability and improve monetary savings in organizations. Safety management systems employ a businesslike approach to identify hazards and control risks. The rapid advances in the technology and World Wide Web have led to the development of various safety management software. Currently available software systems provide a complete picture of the safety data to all safety and security stakeholders, internal company inspectors, safety managers, third party inspectors, certifiers and governing bodies so as to perform an efficient safety audit. This provides an unprecedented choice in conducting safety audits.

An existing system provides a web based means for efficiently managing safety inspection. The system utilizes a combination of advanced identification, mobile devices and the web to provide a customizable, asset specific safety inspection to an organization as required by OSHA. The system also employs a safety tracking software to identify hazards. The downside to this system is that it does not offer professional safety expert support to the customers and hence it is very difficult for the customers to set up and manage the safety checklists for each asset. Further, the system does not provide scheduled maintenance which results in safety risk conditions in the workplaces.

There are several other systems that were developed to computerize safety management functions to perform machine safety audits. Such systems allow the customer to schedule, manage and customize safety inspection checklists. Customers can also track accidents, investigations, safety inspections and corrective actions. The organizations can manage and track OSHA compliance inspections in an easier manner by purchasing these software products. However, this system does not include machine safety checklists thereby leaving the time consuming job of designing these checklists to the customer. Moreover, this system does not provide employee training which in turn may cause difficulty to the customer.

Hence, it can be seen that there is a need for a web-based, computer implemented system that would provide an improved means to manage machine safety audits. Such a system would need to provide machine specific safety checklists for the customer to conduct the audits with ease. The system would offer the customer with professional safety expert support to assist the audits. Further, the system would offer training courses to the customer. This system would track machine lifecycle and provide scheduled maintenance activities to track machine safety on a timely basis. Moreover, the system would provide integrated audit and maintenance data to the customer. In addition, this system would provide multi level security to the customer by allowing more employees to access the system.

### SUMMARY OF THE INVENTION

The present invention provides an online audit management system for providing an improved means to manage a plurality of machine safety audits. The present invention comprises at least one customer associated with a customer account, at least one user sign on associated with the at least one customer, a home page configured as a default start page, an about page configured to direct the at least one user to the home page, an administration page configured to conduct a plurality of administrative tasks, a profile page configured to allow the at least one user to manage at least one profile, a contacts page configured to display contact information of the at least one user, a reports page configured to include a pair of pre-packaged reports, a toolbox page configured to include a plurality of tools, a machines page configured to manage information of a plurality of machines, an audits page configured to manage the plurality of machine safety audits, a help page configured to provide additional help documents and support information to the at least one user, and a remote database configured to store data related to the plurality of machine safety audits. The present invention allows the at least one user to conduct and store the plurality of machine safety audits in a simple, secure and cost-effective manner.

A first objective of the present invention is to provide a web-based audit management system to manage machine safety audits.

A second objective of the invention is to provide a system that allows at least one user to easily conduct the audits by means of lists of custom machine specific safety questions.

A third objective of the invention is to provide a system that provides integrated audit and maintenance data to the customer.

Yet another objective of the invention is to provide a multi level security to the customer by allowing more users to access the system.

Still another objective of the invention is to provide an online audit management system that allows the customer to verify safety compliance of machines.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a schematic diagram of an online audit management system in accordance with the present invention;

FIG. 2 illustrates a home page of an online audit management system in accordance with the present invention;

FIG. 3 illustrates an administration page of the online audit management system in accordance with the present invention;

FIG. 4 illustrates a profile page of the online audit management system in accordance with the present invention;

FIG. 5 illustrates a contacts page of the online audit management system in accordance with the present invention;

FIG. 6 illustrates a reports page of the online audit management system in accordance with the present invention;

FIG. 7 illustrates a toolbox page of the online audit management system in accordance with the present invention;

FIG. 8 illustrates a machines page of the online audit management system in accordance with the present invention; and

FIG. 9 illustrates an audits page of the online audit management system in accordance with the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

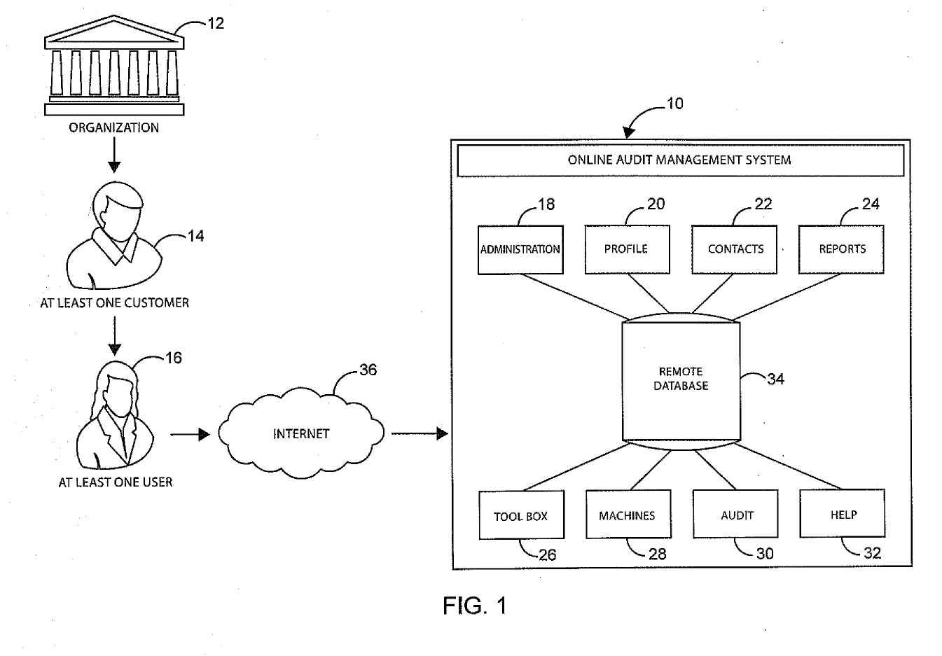

Turning first to FIG. 1, a schematic diagram of an online audit management system 10 for managing a plurality of machine safety audits in accordance with the present invention is illustrated. The online audit management system 10 can be purchased by an organization 12 to conduct machine safety audits. At least one user 16 representing the customer 14 can login to the system 10 utilizing the at least one customer sign on. The organization 12 may be selected from a group consisting of: school, business organization and insurance company. The at least one customer 14 assigns the task of managing the plurality of machine safety audits to at least one user 16. The at least one user 16 with nominal training is able to conduct the plurality of machine safety audits. The at least one user 16 can access the system 10 via the Internet 36 utilizing at least one user account. The online audit management system 10 comprises a home page 38 configured as a default start page, an about page configured to direct the at least one user 16 to the home page, an administration page 18 configured to conduct a plurality of administrative tasks, a profile page 20 configured to allow the at least one user 16 to manage at least one profile, a contacts page 22 configured to display contact information of the at least one user 16, a reports page 24 configured to include a pair of pre-packaged reports, a toolbox page 26 configured to include a plurality of tools, a machines page 28 configured to manage information of a plurality of machines, an audits page 30 configured to manage the plurality of machine safety audits, a help page 32 configured to provide additional help documents and support information to the at least one user 16, and a remote database 34 configured to store data related to the plurality of machine safety audits. The present invention allows the at least one user 16 to conduct and store the plurality of machine safety audits in a simple, secure and cost-effective manner.

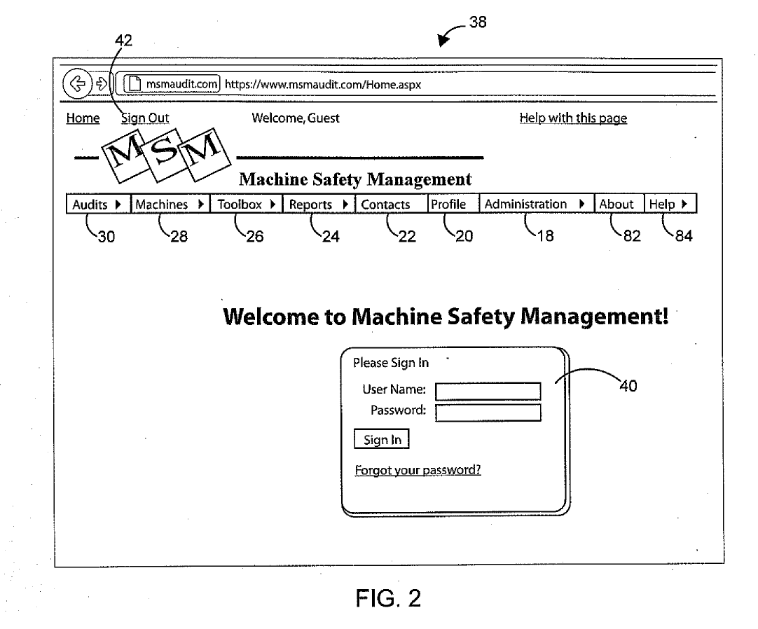

Referring to FIG. 2, the home page 38 of the online audit management system 10 in accordance with the present invention is illustrated. The home page 38 is configured as a default start page and is displayed when the system 10 is initially launched. When the system 10 is initially accessed, the home page 38 will be displayed to the at least one user 16. The at least one user 16 logs into the system 10 utilizing the at least one user account. The home page 38 includes a sign in section 40 to allow the at least one user 16 to sign on to the system 10. The system 10 also includes a sign out section 42 configured to allow the at least one user 16 to sign out from the system 10. The at least one user 16 can access the system 10 utilizing the at least one user sign on to verify the safety compliance of: the machines. The at least one user sign on may be selected from a group consisting of: single customer sign on and a multi customer sign on. A user with a single customer sign on is restricted to accessing the customer data for which the sign-on is created, while a user with the multi customer sign on can access the system 10 in a view only mode. The multi customer sign on offers the at least one user 16 an ability to view the data of a defined subset of customers. A user with a multi-customer sign-on is first presented with the switch customer page, which consists of a selectable list of child customers accessible from the multi customer sign on. Once the user with a multi-customer sign on selects a child customer, he is privileged to view the child customer's identity and data. For instance, an insurance company which has several school districts as clients can be given a user multi customer sign on which has the ability to switch between the school districts to access their data to verify the safety compliance of the school districts.

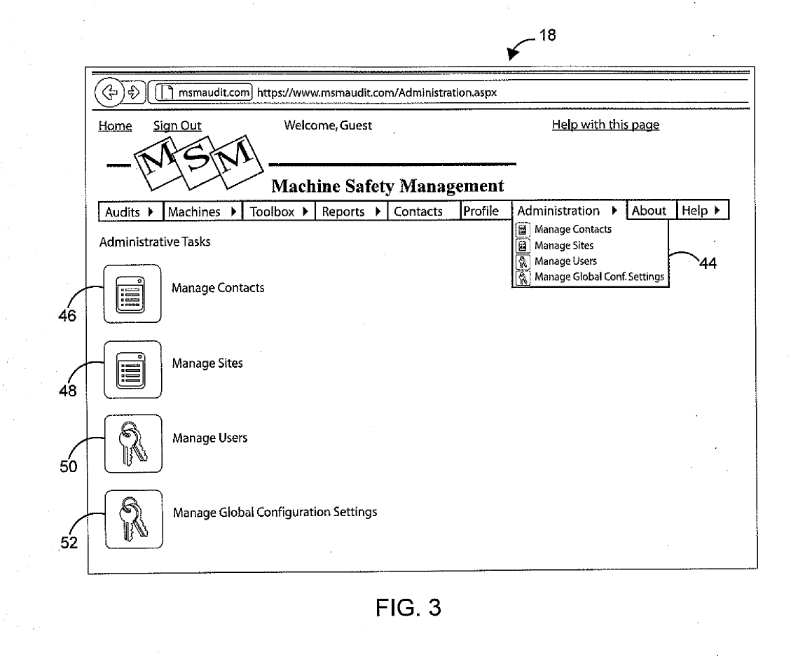

FIG. 3 illustrates the administration page 18 of the online audit management system 10 in accordance with the preferred embodiment of the present invention. The administration page 18 is configured to conduct the plurality of administrative tasks. The administration page 18 includes a plurality of tabs 44 related to the plurality of administrative tasks. The plurality of tabs 44 related to the plurality of administrative tasks includes: manage contacts 46, manage sites 48, manage users 50 and global configuration 52. The at least one user 16 assumes the role of a program administrator for maintaining and managing the plurality of safety audits in each individual site in the administration page 18. The program administrator may create additional users for each site. The at least one user 16 created by the program administrator may be selected from a group consisting of: program administrator, a site administrator, an instructor, a maintenance person, and an external surveyor. The at least one user 16 may also be assigned with role modifiers such as surveyor, view only and hot work permit. The “view only” modifier allows the user 16 to access the system 10 in a view only mode. By selecting a “surveyor” role modifier, the user 16 will be allowed to edit machine surveys required to perform the audits. The “Hot work permits” role modifier allows the user 16 to create hot work permits.

By selecting manage users tab 50 from the administration page 18, a program administrator or site administrator can add users and view the list of users. While creating a new user, role of the user may be selected from a list of “Roles” in the manage users tab 50. By selecting the “Surveyor” role, the at least one user 16 can create audits and conduct machine surveys. The new user can be created by clicking “Add user” tab. Contact information of the new user can be entered and saved by clicking “Create User”. The system 10 provides option for choosing a default password, a security question and answer to be initially aligned to all new users. The at least one user 16 may edit the information at their first login to the system 10. The manage contacts tab 46 allows the program administrator and the site administrator to edit contacts. There are two types of contacts: contacts with a user ID and contacts without a user ID. All new users created by a program administrator or site administrator, will be automatically added to the contact list of the system. Contacts can be assigned to a site, building and/or room to keep track of who is responsible for a specific location.

Clicking on the manage sites tab 48 allows the program administrators and site administrators to enter site, building and room information. This information must be entered and machines must be added to the rooms before any audits can be created. Once the site, building and room information is entered, users and contacts may be linked to those locations. The system 10 provides the option to add new sites, add new buildings within these sites and further new rooms within the added buildings. The program administrator can also edit the information of the site, building and room at any time by clicking the “Edit” tab. The changes can be saved to the system using the “Update” tab. The global configuration tab 52 allows the program administrator to manage the number of days between the audits. In addition, the program administrator also has the option to view regulations by clicking a Show Regulation Buttons box. The show Regulation Buttons box will display question specific government regulations.

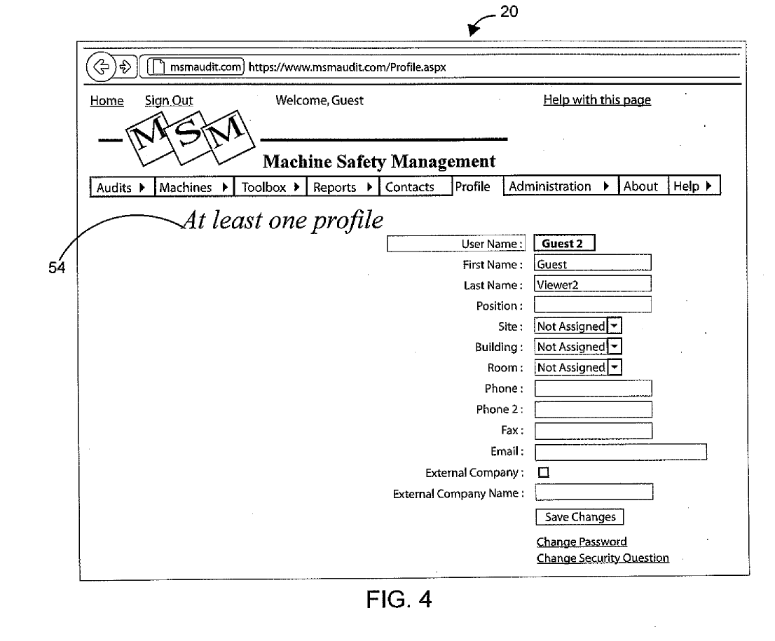

FIG. 4 illustrates the profile page 20 of the online audit management system 10 in accordance with the present invention. The profile page 20 is configured to allow the at least one user 16 to manage the at least one profile 54. The at least one profile 54 is created utilizing the at least one user account. The at least one user 16 can set their location and edit the location information such as site, building or room to associate personnel with physical locations. The location set by the at least one user 16 will be set as their default location.

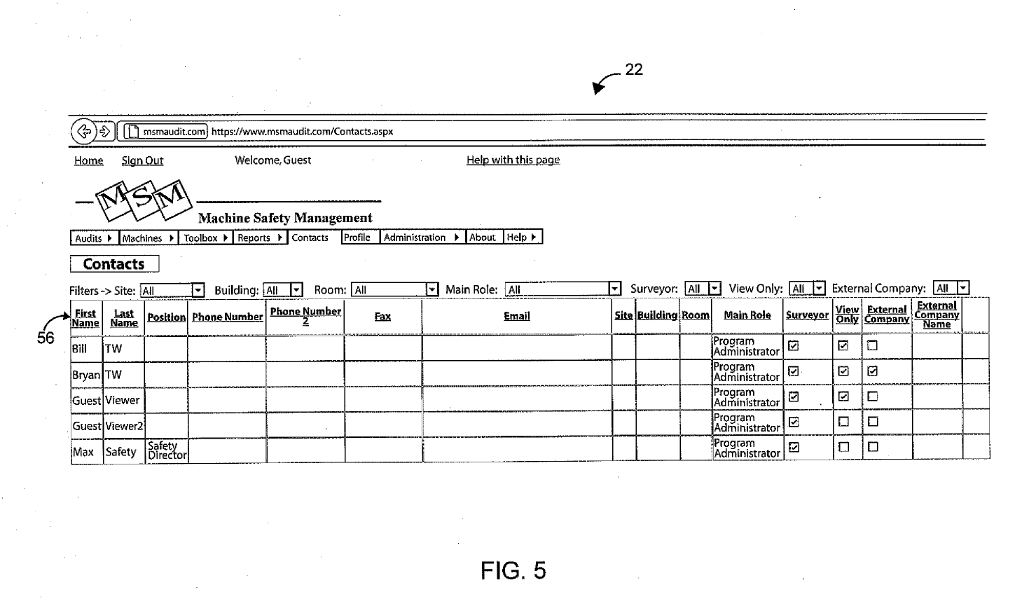

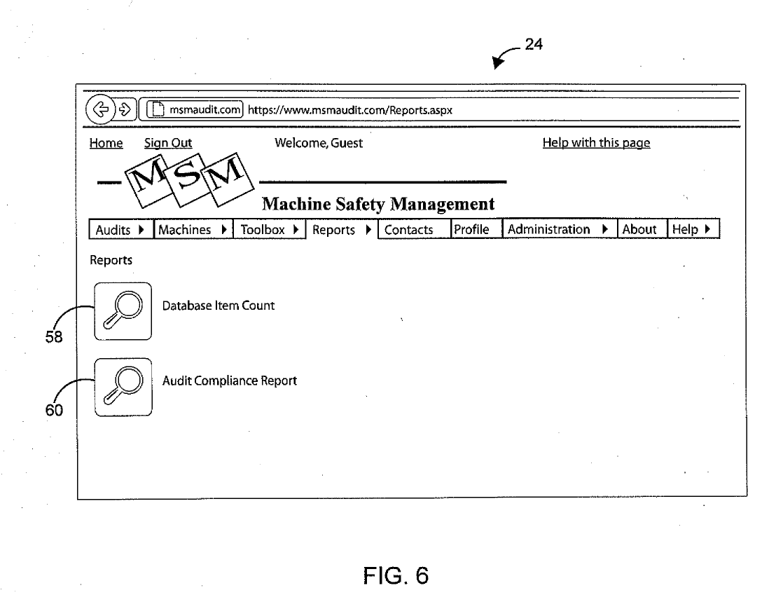

Referring to FIG. 5, the contacts page 22 of the online audit management system 10 in accordance with the present invention is illustrated. The contacts page 22 is configured to display contact list 56 of the at least one customer. The at least one user 16 can edit the details of the contact. All new users created by the program administrator, will be automatically added to the contact list 56 of the system 10. FIG. 6 illustrates the reports page 24 of the online audit management system 10 in accordance with the present invention. The reports page 24 is configured to include a pair of pre-packaged reports. The pair of pre-packaged reports includes a database item count 58 and an audit compliance report 60. The database item count 58 lists the number of items the at least one customer has in the remote database 34. The audit compliance report 60 is a one stop overview of the audit timelines. The audit compliance report 60 displays information on the most recent completed audit for a site and the number of days that have passed since the audit was completed.

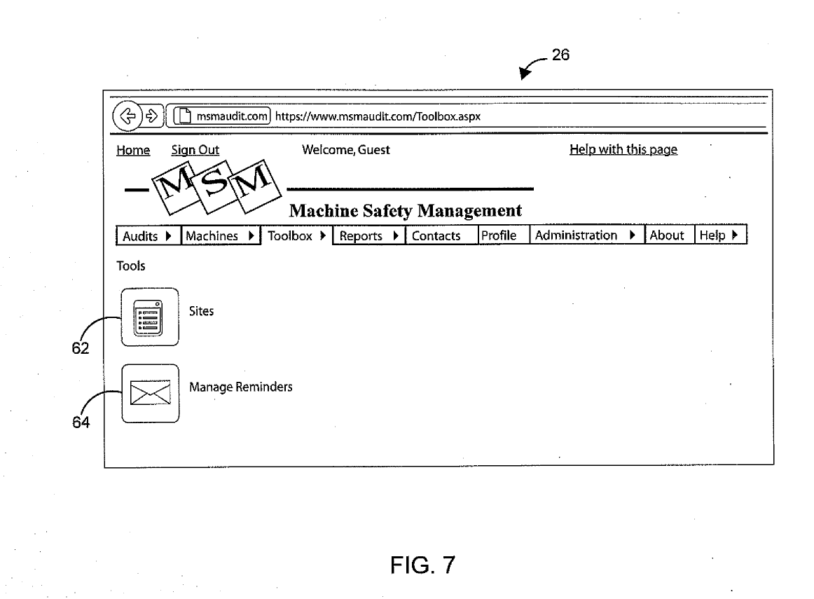

FIG. 7 illustrates the toolbox page 26 of the online audit management system 10 in accordance with the present invention. The toolbox page 26 is configured to include a pair of tools to manage the system 10. The pair of tools includes sites tab 62 and manage reminders tab 64. The sites tab 62 allows the at least one user 16 to view site, building information, room information, contact information, room types and machine counts. The manage reminders tab 64 allows the at least one user 16 to set up automatic reminder emails for various events in the system 10.

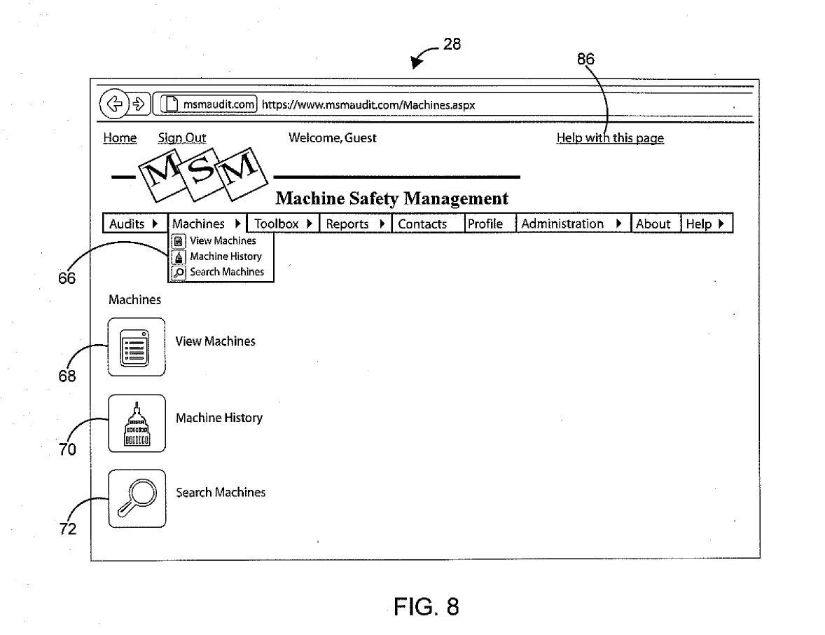

FIG. 8 illustrates the machines page 28 of the online audit management system 10 in accordance with the present invention. The machines page 28 is configured to manage information of the plurality of machines in the system 10. The machines page 28 includes a plurality of tabs 66 which includes view machines tab 68, machines history tab 70 and search machines tab 72. The plurality of tabs 66 can also be opened by selecting manage sites tab 48 in the administration page 18 or by selecting sites tab 62 in the toolbox page 26 or by selecting view machines tab 68 in the machines page 28. The view machines tab 68 allows the at least one user 16 to view all the machines included in the system 10. The at least one user 16 can add new machines to the system 10 by selecting a “New” tab. The machines page 28 offers the customer an option to add machines to each room by selecting the specific site, building and room. The information of the machines can also be edited in the same manner by selecting “Edit” tab. Editing of the machine information allows the customer to add machine ID photo to the system 10. If a machine is relocated to a different room, site or building, the machine information may also be changed accordingly to reflect the new location in the system 10. The machine that requires relocation can be moved by choosing “Move” tab. The machine move will be automatically recorded in the machines history. If a machine is removed from a site, it should be removed from the remote database 34 as well. This is done by moving the machine to a “Discarded machines” list. The plurality of machines may be selected from a group consisting of: saw, grinder, sander, drill press, router, lathe and other machines covered by OSHA.

The machines history tab 70 tracks changes to machines specifications in the remote database 34. The users may also have the option to create machine log entries manually for machine maintenance or products installed on the machines. By selecting the machines history tab 70, a table with the history of all machines will be displayed with the most recent history at the top of the table. In order to view a specific machine's history, the at least one user 16 can enter the machine ID number and click a “View” tab. Once a specific machine's history is displayed, machine log entries table and changes to machine specifications table will be also be displayed. The machine log entries table automatically records the audit logs and move logs when those actions are performed. The machine logs tables allows the user 16 to manually record products installed on a machine, photos of machines, notes or issues with a machine and additional machine specifications. The changes to machine specifications table is completely automatic and records the changes in machine information, changes in machine ID photo and machine survey results. A machine safety knowledge base is built into the system that includes a plurality of machine survey questions for conducting a machine survey. The at least one user 16 can conduct the machine survey by answering the plurality of machine survey questions.

The search machines tab 72 provides an easy and quick way to search machines in the remote database 34. Such searches are conducted for determining a number of factors pertaining to the machines. For instance, the at least one user 16 can view the number of machines or the machines which utilizes interlocked guarding. The search machines tab 72 also allows the user 16 to modify the search using drop down menus. The list of discarded machines can also be viewed using the search machines tab 72 by selecting “Discarded Machines”. Researching the reasons, methods and special circumstances surrounding the decision to discard machines enables the user to better understand the machine lifecycle, which in turn, allows for more informed purchasing decisions.

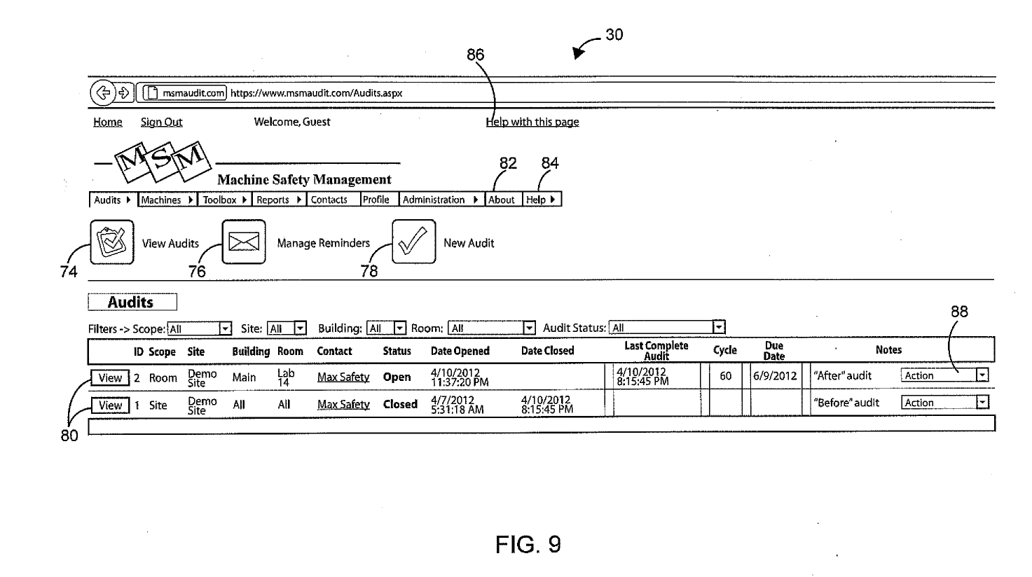

Referring to FIG. 9, the audits page 30 of the online audit management system 10 in accordance with the present invention is illustrated. The audits page 30 includes view audits tab 74, manage reminders tab 76 and new audit tab 78. By selecting the view audits tab 74, all the audits recorded in the remote database 34 will be displayed. The new audit tab 78 allows the at least one user 16 to conduct a new audit. After entering the details of the new audit, the user can click “Create Audit”. The default scope for all new audits is site. Alternately, audits may be required based on buildings, rooms and all other sites. In such situations, only the program administrator can create a new audit with scope other than site. The new audit thus created can be viewed by clicking the view audits tab 74. The manage reminders tab 76 is arranged to periodically sent reminder emails to users and contacts as a reminder when the audits are due or past due. Audit reminders may be set for an entire site, building or a single room. Also, the users are notified when the audit needs attention. This feature is configurable by the program administrator.

The view audits tab 74 allows the at least one user 16 to conduct the machine survey. To open a new audit, the at least one user 16 can click “View” tab 80 in the audits page 30. The customer can scroll to the machine to be surveyed and then click a “Survey” tab. The at least one user 16 with nominal training is able to conduct the machine safety audits. The machine survey includes a plurality of machine survey questions assigned to a machine type. The system 10 is pre-loaded with custom machine types, custom machine surveys and custom survey questions which are fully integrated within the knowledge base of the system 10 and cannot be changed by the user 16. This allows the user 16 to easily conduct the plurality of machine surveys by filling out the survey questions in a simple manner. The machine survey questions may be a series of Yes/No questions that are designed to lead the user 16 through the process of conducting audits. After conducting the machine survey by answering the survey questions, the user 16 can select “Submit Survey” tab to submit the survey to the remote database 34. The user 16 can also upload picture depicting the condition of the machines, which helps the customer 14 to identify properly guarded machines and un-guarded machines. Each of the machine survey questions will be displayed with a plurality of question specific government regulations and suggested solutions.

Alternately, the user 16 may also create custom machine surveys for custom machine types. The user 16 may first create a custom machine type and add it to a custom machine type structure. Machine types are organized in a tree structure, with each node being either a machine type or a machine type category. The machine type structure is simply the remote database 34 which holds the list of machines and the machine type category may include a group of machines. Once a machine type is created, the user 16 can attach custom survey questions to build a custom machine survey. Machine survey questions, once created, are attached to nodes in the machine type structure. As part of conducting the survey, the new questions will appear on any machine designated with new custom machine type. The system 10 also allows the user 16 to create custom maintenance checklists which may be assigned to an individual machine or any node in the machine type structure.

In addition, the system 10 allows the user 16 to filter the survey on basis of site, building, room, machine type, manufacturer, survey status, guarding status, color coding status and attached photos. Thus, each of the plurality of machine safety audits includes a plurality of machine surveys. Each of the plurality of machine surveys is conducted for a machine in a specific site, building or room. When all machines are surveyed and the audit is complete, the audit may be closed by a two-step process. Initially, a “Close Audit” tab may be selected by the user 16. If the audit is not complete, a warning message will be displayed. The user 16 can close the audit, view the audit or cancel the audit. Once an audit is closed, it is locked and can no longer be edited. The user 16 can later on sign in to the system 10 and view the audits from the remote database 34 to verify audit compliance and condition of the machines.

The system 10 is embedded with features to add documents related to audits, sites, buildings, rooms, machines etc. Documents thus attached may be viewed by navigating to “Action” dropdown menu 88, which will open a documents window with a list of documents attached to the object. Documents window allows the user 16 to view, add, delete and edit the document information. This allows the user 16 to have one repository for all owner manuals, lock out, tag out procedures etc. Moreover, the system 10 includes operator or student training record repository. The system 10 provides training to the users by providing various education modules selected from a group consisting of: OSHA history, OSHA regulations, terminology, American National Standards Institute (ANSI), machine problems, machine safeguarding, machine electrical safeguarding, machine inspection, system usage etc.

System 10 also includes an about page 82 configured to direct the at least one user 16 to the home page 38. A help page 84 is configured to provide additional help documents and support information to the at least one user 16. In addition, the system also includes a “Help with this page” tab 86, which provides the help to the user 16 in problems related to the currently displayed page. The system 10 thus provides an easy-to-access, web-based system to manage machine safety audits. The system 10 allows the user 16 to easily conduct the audits by providing them with lists of custom machine specific safety questions. By maintaining an integrated audit and maintenance data, the system 10 enables an efficient means to track the machine lifecycle. In addition, this system provides multi level security to the customer 14 by allowing more users to access the system. The system 10 will also be available as mobile application compatible with mobile devices. Finally, the system 10 is cost-effective and hence can be easily purchased by the customer 14.

The foregoing description of the preferred embodiment of the present invention has been presented for the purpose of illustration and description. It is not intended to be exhaustive or to limit the invention to the precise form disclosed. Many modifications and variations are possible in light of the above teachings. For example, the appearance of the online audit management system 10 may be different depending on the display and the designing tool of the device on which the system 10 is run. It is intended that the scope of the present invention not be limited by this detailed description, but by the claims and the equivalents to the claims appended hereto.

We claim:

1. An online audit management system for managing a plurality of machine safety audits, the system comprising:
at least one customer, the at least one customer represents an organization conducting the machine safety audits;
at least one user account associated with the at least one customer, the at least one user being assigned with managing the machine safety audits by the at least one customer;
a home page configured as a default start page, the home page being displayed when the system is initially launched;
an about page configured to direct the at least one user to the home page;
an administration page configured to conduct a plurality of administrative tasks, the administration page includes a plurality of tabs related to the plurality of administrative tasks;
a profile page configured to allow the at least one user to manage at least one profile, the at least one profile being created utilizing the at least one user account;
a contacts page configured to display contact information of the at least one customer;
a reports page configured to include a pair of pre-packaged reports;
a toolbox page configured to include a pair of tools, the pair of tools being adaptable to manage the system;
a machines page configured to manage information of a plurality of machines;
an audits page configured to manage the plurality of machine safety audits;
a help page configured to provide additional help documents and support information to the at least one user;
a sign out section configured to allow the at least one user to sign out from the system;
a machine safety knowledge base built into the system, the machine safety knowledge base includes a plurality of machine survey questions for conducting a machine survey; and
a remote database configured to store data related to the plurality of machine safety audits;
whereby the system allows the at least one user to conduct and store the plurality of machine safety audits in a simple, secure and cost-effective manner.

2. The system of claim 1 wherein the at least one user sign on may be selected from a group consisting of: single customer sign on and a multi customer sign on.

3. The system of claim 2 wherein the multi customer sign on allows the at least one user to view data of a defined set of customers.

4. The system of claim 1 wherein the at least one user with nominal training is able to conduct the machine safety audits.

5. The system of claim 1 wherein the at least one user access the system utilizing the at least one user account.

6. The system of claim 1 wherein the at least one user conducts the machine survey by answering the plurality of machine survey questions.

7. The system of claim 1 wherein each of the plurality of machine safety audits includes a plurality of machine surveys, each of the plurality of machine surveys being conducted for a machine in a specific location.

8. The system of claim 1 wherein the at least one user may be selected from a group consisting of: program administrator, a site administrator, an instructor, a maintenance person, and an external surveyor.

9. The system of claim 1 wherein the plurality of tabs related to the plurality of administrative tasks includes: manage contacts, manage sites, manage users and global configuration.

10. The system of claim 1 wherein the pair of pre-packaged reports includes a database item count and an audit compliance report.

11. The system of claim 1 wherein the machines page allows the at least one user to view the plurality of machines, view machine history and search the plurality of machines in the system.

12. The system of claim 1 wherein the plurality of machines may be selected from a group consisting of: saw, grinder, sander, drill press, router, lathe and other machines covered by OSHA.

13. The system of claim 1 wherein the audits page allows the at least one user to view audits, manage reminders and create new audit.

14. The system of claim 1 wherein the system can be accessed by the at least one customer utilizing the at least one user sign on to verify the safety compliance of the machines.

15. The system of claim 1 wherein the at least one user can retrieve results of the plurality of machine audits from the remote database.

16. The system of claim 1 wherein the system allows the at least one user to upload documents related to the plurality of machines.

17. The system of claim 1 wherein the system tracks machine lifecycle and schedule maintenance activities to ensure machine safety.
